(19) United States
(12) Patent Application Publication
(10) Pub. No.: US 2023/0139104 A1
(43) Pub. Date: May 4, 2023

(54) AUTHENTICATED ENCRYPTION APPARATUS, AUTHENTICATED DECRYPTION APPARATUS, AUTHENTICATED ENCRYPTION SYSTEM, METHOD, AND COMPUTER READABLE MEDIUM

(71) Applicant: NEC Corporation, Minato-ku, Tokyo (JP)

(72) Inventors: Kazuhiko MINEMATSU, Tokyo (JP); Akiko MUKAI, Tokyo (JP); Naofumi HOMMA, Tokyo (JP); Rei Ueno, Tokyo (JP)

(73) Assignee: NEC Corporation, Minato-ku, Tokyo (JP)

(21) Appl. No.: 17/918,643

(22) PCT Filed: Apr. 23, 2020
(86) PCT No.: PCT/JP2020/017422

§ 371 Date: Oct. 13, 2022

(51) Int. Cl. H04L 9/32; H04L 9/06

(52) U.S. Cl. CPC H04L 9/3234; H04L 9/0618; H04L 9/3239

(57) ABSTRACT

An authenticated encryption apparatus capable of reducing delays in encryption and in decryption is provided. A nonce generation unit generates a nonce different from any of values generated in the past. A plaintext encryption unit generates a ciphertext corresponding to a plaintext by encrypting each of blocks obtained by dividing the plaintext by using the nonce as an auxiliary variable. A checksum generation unit generates a checksum by using the plaintext. A hash unit acquires a hash value. A nonce encryption unit acquires an encrypted nonce by encrypting the nonce. An authentication tag generation unit generates an authentication tag by using the checksum, the hash value, and the encrypted nonce.

### TECHNICAL FIELD

The present invention relates to an authenticated encryption apparatus, an authenticated decryption apparatus, an authenticated encryption system, a method, and a computer readable medium.

### BACKGROUND ART

A technology called an authenticated encryption (AE: Authenticated Encryption) in which encryption of a plaintext message and calculation of an authentication tag for detecting tampering thereof are simultaneously performed by using a secret key that has been shared in advance has been known. By applying the authenticated encryption AE to a communication path, it becomes possible to keep the contents of the message secret against eavesdropping and to detect unauthorized tampering. As a result, it is possible to provide strong protection to the contents of the communication. Regarding the authenticated encryption technology, for example, a technology disclosed in Non-patent Literature 1 has been known.

Further, as one of technologies for efficiently performing such authenticated encryption, an authenticated encryption method called an OCB (Offset Code Book) mode, examples of which are disclosed in Patent Literature 1 and Non-patent Literature 2, has been known. The OCB mode is an extended version of block cipher (block encryption) called Tweakable block cipher, in which an auxiliary variable (an adjustment value) called a Tweak is introduced in the encryption and in the decryption. Specifically, in the OCB mode, encryption using a Tweak is performed by performing encryption in an XEX mode disclosed in Non-patent Literature 2. Further, in the OCB mode, a tag is generated by performing a process similar to the above-described encryption on the exclusive OR of blocks that are obtained by dividing a plaintext.

Further, Non-patent Literature 3 discloses a method for OCB 2f which is a modified version of the OCB disclosed in Non-patent Literature 2. Further, Non-patent Literature 4 discloses a OCB3 method (hereafter referred to as ThetaCB3), in which the OCB is made abstract by using, as a primitive, Tweakable block cipher (TBC: Tweakable block cipher; tweakable block cipher) which is an extended version of block cipher.

### CITATION LIST

### Patent Literature

Patent Literature 1: U.S. Pat. No. 8,321,675

### Non Patent Literature

Non-patent Literature 1: NIST Special Publication 800-38D, “Recommendation for Block Cipher Modes of Operation: Galois/Counter Mode (GCM) and GMAC”, http://csrc.nist.gov/publications/nistpubs/800-38D/SP-800-38D.pdf Non-patent Literature 2: “Efficient Instantiations of Tweakable Blockciphers and Refinements to Modes OCB and PMAC”, Phillip Rogaway, ASIACRYPT 2004, http://web.cs.ucdavis.edu/˜rogaway/papers/offsets.pdf Non-patent Literature 3: Akiko Inoue, Tetsu Iwata, Kazuhiko Minematsu, Bertram Poettering, “Cryptanalysis of OCB 2: Attacks on Authenticity and Confidentiality”, IACR Cryptology ePrint Archive 2019: 311 (2019) Non-patent Literature 4: Ted Krovetz, Phillip Rogaway, “The Software Performance of Authenticated-Encryption Modes”, FSE 2011: 306-327 Non-patent Literature 5: Christof Beierle, Jeremy Jean, Stefan Kolbl, Gregor

Leander, Amir Moradi, Thomas Peyrin, Yu Sasaki, Pascal Sasdrich, Siang Meng Sim, “The SKINNY Family of Block Ciphers and Its Low-Latency Variant MANTIS”, CRYPTO (2) 2016: 123-153 Non-patent Literature 6: Daniel J. Bernstein, “The Poly1305-AES Message-Authentication Code”, FSE 2005: 32-49

### SUMMARY OF INVENTION

### Technical Problem

For ordinary encryption methods including authenticated encryption, a delay is used as one of evaluation indices. This delay indicates a time period from the start of processing to a time at which the first result is output, and is desired to be small. However, it is difficult to shorten the delays in the encryption and in the decryption in the technologies disclosed in the aforementioned patent literature and non-patent literatures.

The present disclosure has been made to solve the above-described problem, and an object thereof is to provide an authenticated encryption apparatus, an authenticated decryption apparatus, an authenticated encryption system, a method, and a computer readable medium capable of reducing delays in encryption and in decryption.

### Solution to Problem

An authenticated encryption apparatus according to the present disclosure include: input means for receiving an input of a plaintext; nonce generation means for generating a nonce different from a value generated in the past; plaintext encryption means for generating a ciphertext corresponding to the plaintext by encrypting each of blocks obtained by dividing the plaintext by using the nonce as an auxiliary variable; checksum generation means for generating a checksum by using the plaintext; hash means for acquiring a hash value; nonce encryption means for acquiring an encrypted nonce by encrypting the nonce; authentication tag generation means for generating an authentication tag by using the checksum, the hash value, and the encrypted nonce; and output means for performing control for outputting the ciphertext and the authentication tag.

Further, an authenticated decryption apparatus according to the present disclosure includes: input means for receiving an input of a ciphertext, an authentication tag, and a nonce; plaintext decryption means for generating a plaintext corresponding to the ciphertext by decrypting each of blocks obtained by dividing the ciphertext by using the nonce as an auxiliary variable; checksum generation means for generating a checksum by using the plaintext; hash means for acquiring a hash value; nonce encryption means for acquiring an encrypted nonce by encrypting the nonce; verification tag generation means for generating a verification tag by using the checksum, the hash value, and the encrypted nonce, the verification tag being an inferred authentication tag; and verification means for verifying whether or not there is tampering by comparing the authentication tag with the verification tag, and performing control for outputting a result of the verification.

Further, an authenticated encryption system according to the present disclosure includes: an authenticated encryption apparatus, and an authenticated decryption apparatus configured to communicate with the authenticated encryption apparatus, in which the authenticated encryption apparatus includes: first input means for receiving an input of a plaintext; nonce generation means for generating a nonce different from a value generated in the past; plaintext encryption means for generating a ciphertext corresponding to the plaintext by encrypting each of blocks obtained by dividing the plaintext by using the nonce as an auxiliary variable; first checksum generation means for generating a checksum by using the plaintext; first hash means for acquiring a hash value; first nonce encryption means for acquiring an encrypted nonce by encrypting the nonce; authentication tag generation means for generating an authentication tag by using the checksum, the hash value, and the encrypted nonce; and output means for performing control for outputting the ciphertext and the authentication tag, and the authenticated decryption apparatus includes: second input means for receiving an input of a ciphertext, an authentication tag, and a nonce; plaintext decryption means for generating a plaintext corresponding to the ciphertext by decrypting each of blocks obtained by dividing the ciphertext input through the second input means by using the nonce input through the second input means as an auxiliary variable; second checksum generation means for generating a checksum by using the plaintext generated by the plaintext decryption means; second hash means for acquiring a hash value; second nonce encryption means for acquiring an encrypted nonce by encrypting the nonce input through the second input means; verification tag generation means for generating a verification tag by using the checksum generated by the second checksum generation means, the hash value acquired by the second hash means, and the encrypted nonce acquired by the second nonce encryption means, the verification tag being an inferred authentication tag; and verification means for verifying whether or not there is tampering by comparing the authentication tag generated by the authentication tag generation means with the verification tag, and performing control for outputting a result of the verification.

Further, an authenticated encryption method according to the present disclosure includes: receiving an input of a plaintext; generating a nonce different from a value generated in the past; generating a ciphertext corresponding to the plaintext by encrypting each of blocks obtained by dividing the plaintext by using the nonce as an auxiliary variable; generating a checksum by using the plaintext;

acquiring a hash value; acquiring an encrypted nonce by encrypting the nonce; generating an authentication tag by using the checksum, the hash value, and the encrypted nonce; and performing control for outputting the ciphertext and the authentication tag.

Further, an authenticated decryption method according to the present disclosure includes: receiving an input of a ciphertext, an authentication tag, and a nonce; generating a plaintext corresponding to the ciphertext by decrypting each of blocks obtained by dividing the ciphertext by using the nonce as an auxiliary variable; generating a checksum by using the plaintext; acquiring a hash value;

acquiring an encrypted nonce by encrypting the nonce; generating a verification tag by using the checksum, the hash value, and the encrypted nonce, the verification tag being an inferred authentication tag; and verifying whether or not there is tampering by comparing the authentication tag with the verification tag, and performing control for outputting a result of the verification.

Further, a program according to the present disclosure causes a computer to perform: a step of receiving an input of a plaintext; a step of generating a nonce different from a value generated in the past; a step of generating a ciphertext corresponding to the plaintext by encrypting each of blocks obtained by dividing the plaintext by using the nonce as an auxiliary variable; a step of generating a checksum by using the plaintext; a step of acquiring a hash value; a step of acquiring an encrypted nonce by encrypting the nonce; a step of generating an authentication tag by using the checksum, the hash value, and the encrypted nonce; and a step of performing control for outputting the ciphertext and the authentication tag.

Further, a program according to the present disclosure causes a computer to perform: a step of receiving an input of a ciphertext, an authentication tag, and a nonce; a step of generating a plaintext corresponding to the ciphertext by decrypting each of blocks obtained by dividing the ciphertext by using the nonce as an auxiliary variable; a step of generating a checksum by using the plaintext; a step of acquiring a hash value; a step of acquiring an encrypted nonce by encrypting the nonce; a step of generating a verification tag by using the checksum, the hash value, and the encrypted nonce, the verification tag being an inferred authentication tag; and a step of verifying whether or not there is tampering by comparing the authentication tag with the verification tag, and performing control for outputting a result of the verification.

### Advantageous Effects of Invention

According to the present disclosure, it is possible to provide an authenticated encryption apparatus, an authenticated decryption apparatus, an authenticated encryption system, a method, and a computer readable medium capable of reducing delays in encryption and in decryption.

### BRIEF DESCRIPTION OF DRAWINGS

FIG. 1 shows a configuration of an authenticated encryption system according to a first example embodiment;

FIG. 2 shows a configuration of an authenticated encryption apparatus according to the first example embodiment;

FIG. 3 shows a configuration of an authenticated decryption apparatus according to the first example embodiment;

FIG. 4 is a flowchart showing an authenticated encryption method performed by the authenticated encryption apparatus according to the first example embodiment;

FIG. 5 is a flowchart showing an authenticated decryption method performed by the authenticated decryption apparatus according to the first example embodiment;

FIG. 6 is a simplified diagram of an encryption routine using an authenticated encryption method disclosed in Non-patent Literature 4, i.e., a ThetaCB3 method;

FIG. 7 is a simplified diagram of a decryption routine using the authenticated encryption method disclosed in Non-patent Literature 4, i.e., the ThetaCB3 method;

FIG. 8 shows an example of an encryption process in the case where the authenticated encryption method according to the first example embodiment is performed by using Tweakable block cipher;

FIG. 9 shows an example of a decryption process in the case where the authenticated encryption method according to the first example embodiment is performed by using Tweakable block cipher;

FIG. 10 shows an example of an encryption function and a decryption function disclosed in Non-patent Literature 2;

FIG. 11 shows an authenticated encryption apparatus according to a second example embodiment;

FIG. 12 shows an authenticated decryption apparatus according to the second example embodiment; and

FIG. 13 is a block diagram schematically showing an example of a hardware configuration of an arithmetic processing apparatus capable of implementing an apparatus(es) and a system according to each example embodiment.

### EXAMPLE EMBODIMENT

### Outline of Example Embodiment according to Present Disclosure

Prior to describing an example embodiment according to the present disclosure, an outline of the example embodiment according to the present disclosure will be described. Note that although the example embodiment according to the present disclosure will be described hereinafter, the invention is not limited to the below-shown example embodiment. Further, not all the features described in the example embodiment are essential as means for solving the problem according to the invention.

Basic input/output of authenticated encryption (AE) will be described. Note that, in the following description, it is assumed that Alice and Bob, who are two persons sharing a private key K, communicate with each other, and a message encrypted by authenticated encryption is transmitted from Alice to Bob. Further, the method described hereinafter is implemented, for example, according to a GCM (Galois/Counter Mode) algorithm disclosed in Non-patent Literature 1.

The encryption function of the authenticated encryption is represented by AEnc and the decryption function is represented by ADec. Further, a plaintext to be encrypted is represented by M and a variable N called a nonce (Nonce) is introduced. Further, a header (associated data; AD) is represented by A. Note that the header A is a value which is not encrypted but for which detection of tampering is performed.

Firstly, an encryption process performed on the Alice side will be described. After generating a nonce N, Alice carries out a process expressed as (C, T)=AEnc_K(N, A, M). Note that AEnc_K is an encryption function using the key K as a parameter, and C is a ciphertext. Further, T is a variable having a fixed length for detecting tampering, called a tag (an authentication tag). Alice transmits a set (N, A, C, T) composed of the nonce N, the header A, the ciphertext C, and the tag T to Bob.

Next, a decryption process performed by on the Bob side will be described. The information received by Bob is represented by (N′, A′, C′, T′). In this case, Bob carries out a function ADec_K(N′, A′, C T′) as a decryption process. Note that the function ADec_K is a decryption function using the key K as a parameter. If tampering has occurred during the communication and hence information (N′, A′, C T′) is not equal to (N, A, C, T), an error message (an error symbol) indicating that tampering has occurred is output for the function ADec_K(N′, A′, C T′). That is, in this case, the tampering is detected. On the other hand, if no tampering has occurred during the communication and hence the information (N′, A′, C T′) is equal to (N, A, C, T), the plaintext M, which has been encrypted by Alice, is correctly decrypted for the function ADec_K(N′, A′, C′, T′).

Further, in the above-described process, in general, it is important to prevent, in the encryption, the nonce N from accidentally coinciding with its past value. Therefore, on the encryption side, such accidental coincidence of the nonce with its past value is prevented by using some kind of state variable such as a counter. That is, typically, the nonce N that has been used the last time is stored as a state variable, and the nonce N is incremented each time, so that the nonce N does not coincide with any of the past values.

Note that regarding ordinary encryption methods including authenticated encryption, a delay (latency) is used as one of evaluation indices. This delay (latency) indicates a time period from the start of processing to a time at which the first result is output, and it is desired that this delay be small. For example, in the encryption of a memory bus inside a computer or the encryption of communication which needs to be processed in real time, such as control in an online game or control of an unmanned vehicle, the occurrence of a delay is particularly problematic. Therefore, in such a case, it is desired that the delay be small. Note that, in the case of encryption, the delay indicates a time period or an amount of processing done from when a plaintext composed of a plurality of blocks is input to when the first ciphertext block is output.

In the case where a core encryption component used in authenticated encryption is referred to as a primitive, the encryption delay in the authenticated encryption is typically defined as the number of calls to the primitive required before the first ciphertext block is output. The decryption delay is defined in a similar manner. Note that another example of the indices of the delay is a speed (throughput). The speed is typically defined as the number of message blocks that can be processed in one primitive call. This value is also called a rate. However, in general, a certain number of calls that occur irrespective of whether or not a message is processed are not included in the calculation of the rate. That is, the rate indicates an asymptotic speed that is exhibited when the message is sufficiently long. In contrast, the delay may include, by definition, the above-described certain number of calls.

As an example of the authenticated encryption method using block cipher as a primitive, OCB disclosed in Patent Literature 1 and Non-patent Literature 1 has been known. In particular, it has been known that the delay in the OCB is small. Further, for example, in an OCB method disclosed in Non-patent Literature 2 and OCB 2f disclosed in Non-patent Literature 3, the delay in encryption corresponds to two times of block cipher. Further, in a ThetaCB3 method disclosed in Non-patent Literature 4, the delay in encryption corresponds to one TBC, meaning that this method is theoretically the best method among the methods using TBC. In other words, in the OCB and ThetaCB3, the delay in encryption is small. Note that regarding the speed, the rate in encryption and in decryption is 1 in both the OCB and ThetaCB3, that is, in the encryption and decryption of a message, the process can be performed in parallel on a block-by-block basis. Therefore, it can be said that high-speed processing can be performed in the OCB and ThetaCB3.

Note that, in the OCB and ThetaCB3, although the delay in encryption is small, the delay in decryption is larger than the delay in encryption as will be described later. In contrast, in authenticated encryption according to this example embodiment, the delay can be further reduced while achieving a speed roughly equal to the speed in the OCB and ThetaCB3 (i.e., achieving a rate of 1) as will be described later. That is, in this example embodiment, it is possible to carry out high-speed and low-delay authenticated encryption.

### First Example Embodiment

An example embodiment will be described hereinafter with reference to the drawings. The following description and drawings are partially omitted and simplified as appropriate for clarifying the explanation. Further, the same reference numerals (or symbols) are assigned to the same components/structures throughout the drawings, and redundant descriptions thereof are omitted as appropriate.

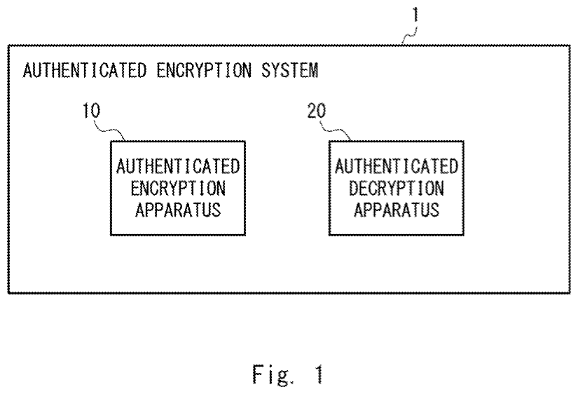

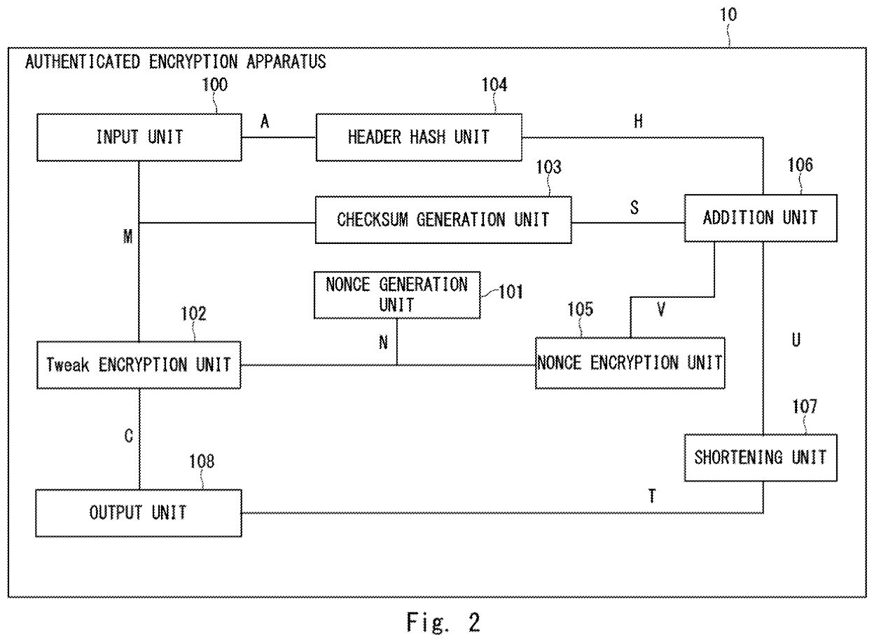

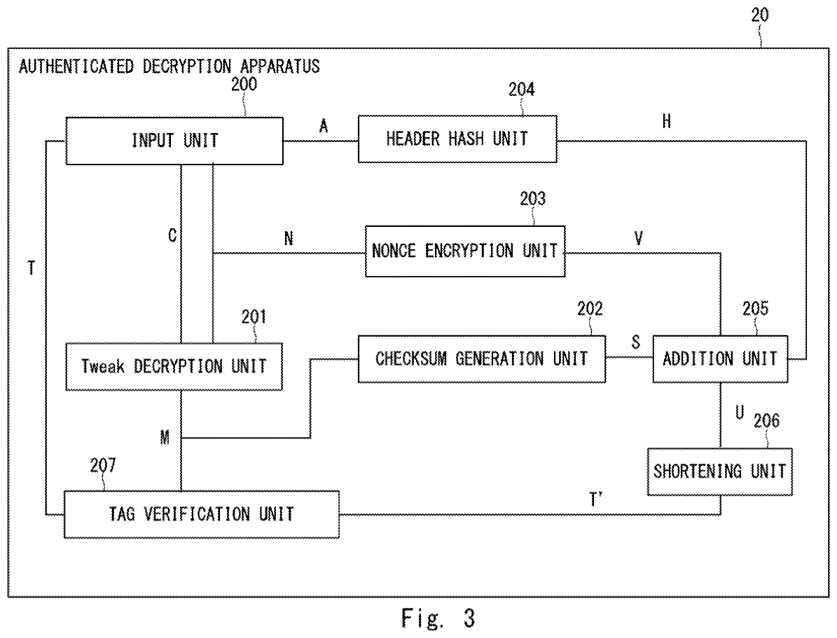

FIG. 1 shows a configuration of an authenticated encryption system 1 according to a first example embodiment. The authenticated encryption system 1 includes an authenticated encryption apparatus 10 and an authenticated decryption apparatus 20. The authenticated encryption apparatus 10 and the authenticated decryption apparatus 20 may be one physically integrated apparatus or may be separate apparatuses. Further, the components of these apparatuses, which will be described below with reference to FIGS. 2 and 3, may be implemented by separate apparatuses. Note that, in the following description, it is assumed that each of a plurality of blocks obtained by dividing a plaintext, a ciphertext or the like has a predetermined length of n bits, unless otherwise specified. Further, in the above-described example of communication between Alice and Bob, the authenticated encryption apparatus 10 corresponds to Alice and the authenticated decryption apparatus 20 corresponds to Bob. That is, communication is performed between the authenticated encryption apparatus 10 and the authenticated decryption apparatus 20.

Note that, in this example embodiment, it is preferable that the length of the plaintext be always equal to a multiple of the block length n. In the case where a plaintext whose length is not equal to a multiple of the block length n is handled, padding is required and the length of a corresponding ciphertext is increased. However, the restriction that the length of a plaintext should be a multiple of the block length do not pose any substantial problem in most applications. For example, in the case where a memory, a cache, or a sector in a hard disc is encrypted by using an AES (Advanced Encryption Standard) (which will be described later), the typical length of a plaintext is a multiple of the block length (16 bytes) in the AES.

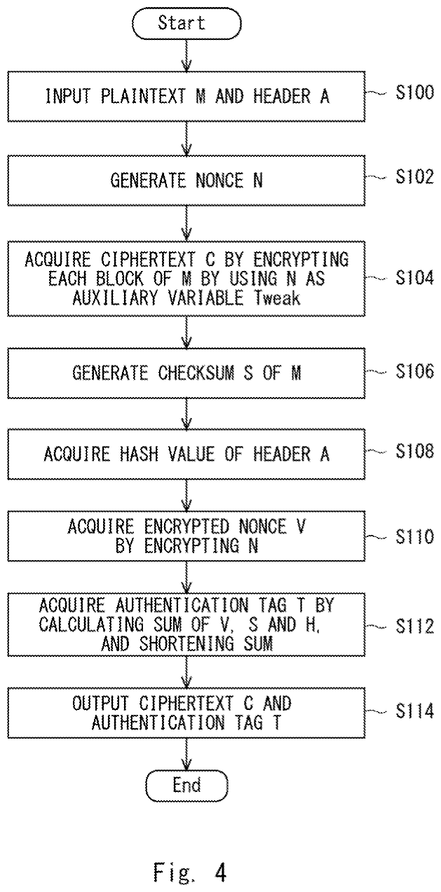

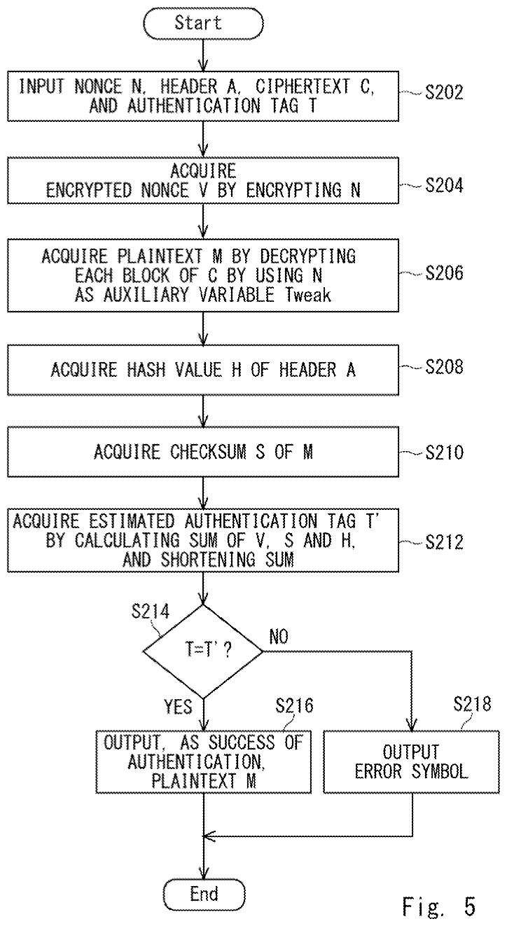

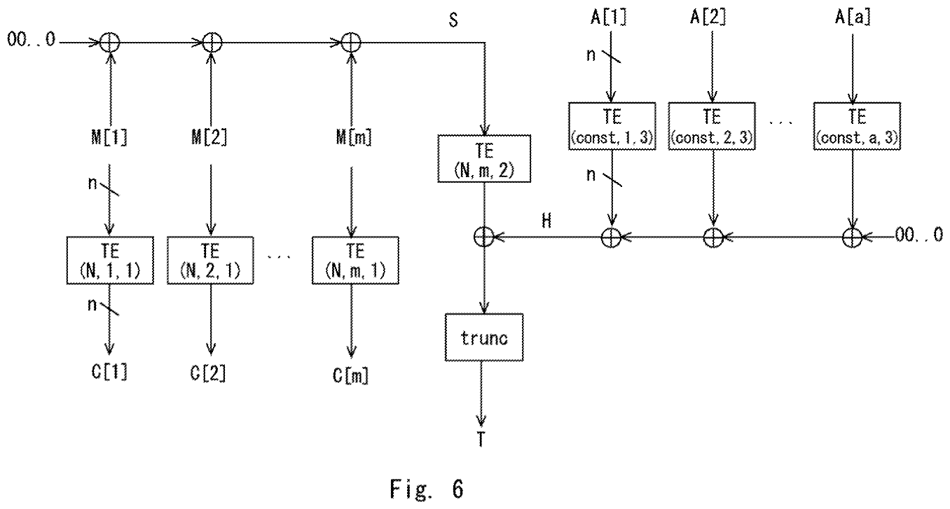

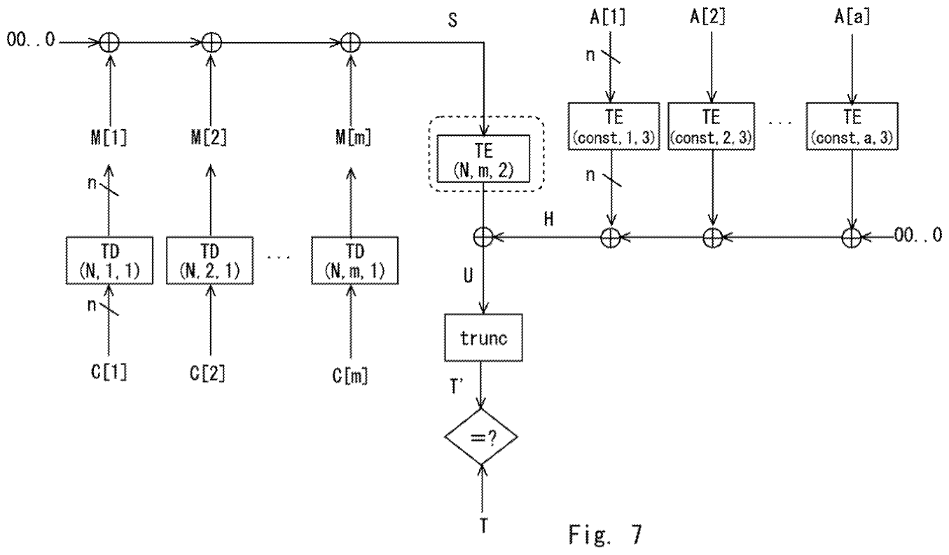

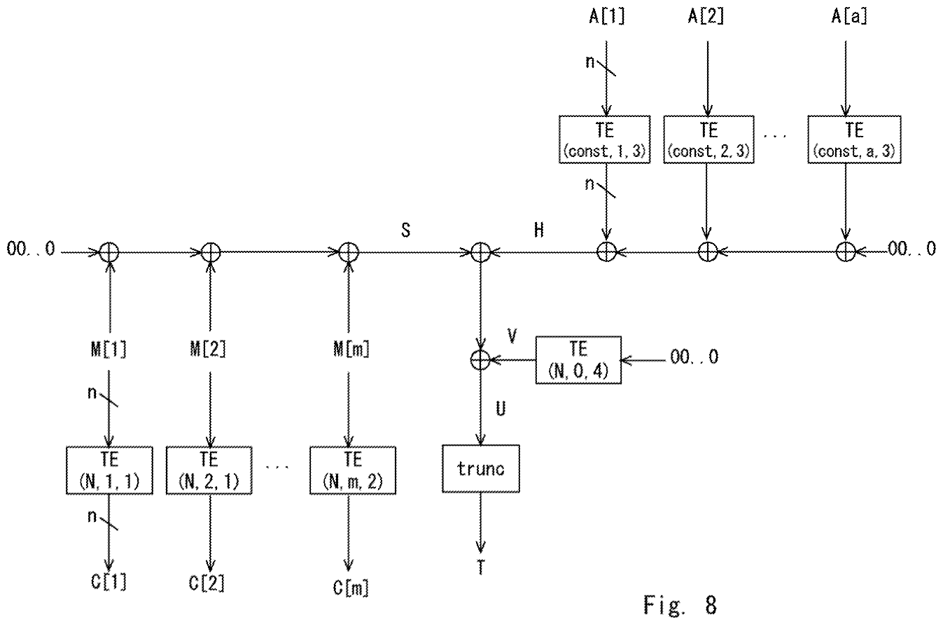

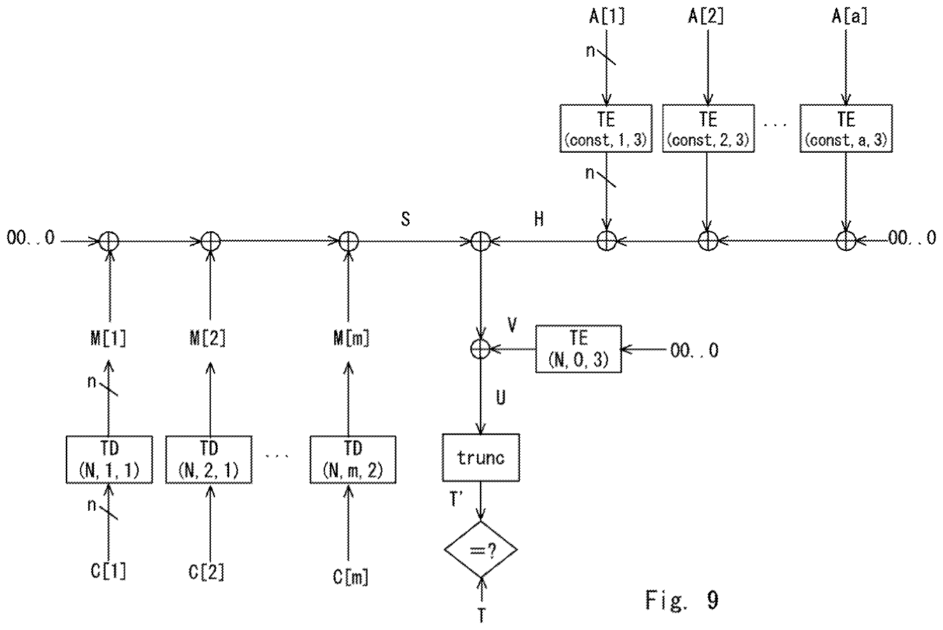

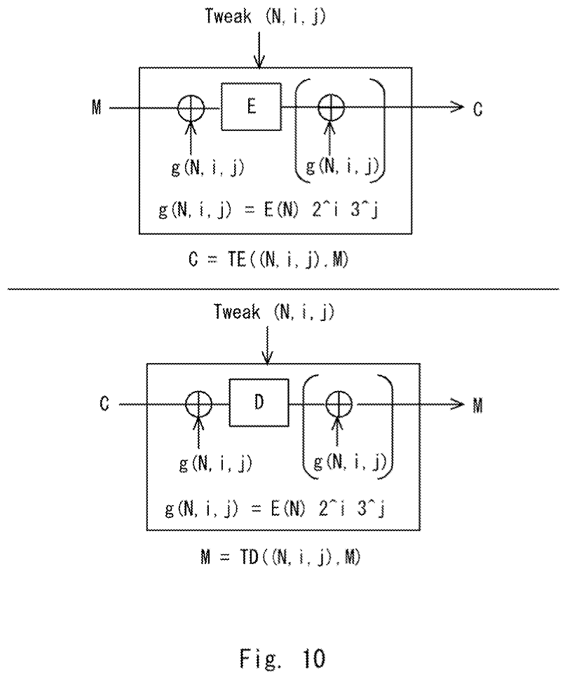

FIG. 2 shows a configuration of the authenticated encryption apparatus 10 according to the first example embodiment. FIG. 3 shows a configuration of the authenticated decryption apparatus 20 according to the first example embodiment. Further, FIG. 4 is a flowchart showing an authenticated encryption method performed by the authenticated encryption apparatus 10 according to the first example embodiment. Further, FIG. 5 is a flowchart showing an authenticated decryption method performed by the authenticated decryption apparatus 20 according to the first example embodiment. Further, FIG. 6 is a simplified diagram of an encryption routine using an authenticated encryption method disclosed in Non-patent Literature 4, i.e., a ThetaCB3 method. Further, FIG. 7 is a simplified diagram of a decryption routine using the authenticated encryption method disclosed in Non-patent Literature 4, i.e., the ThetaCB3 method. Further, FIG. 8 shows an example of an encryption process in the case where the authenticated encryption method according to the first example embodiment is performed by using Tweakable block cipher. Further, FIG. 9 shows an example of a decryption process in the case where the authenticated encryption method according to the first example embodiment is performed by using Tweakable block cipher. Further, FIG. 10 shows an example of an encryption function and a decryption function disclosed in Non-patent Literature 2.

The authenticated encryption apparatus 10 shown in FIG. 2 will be described. The authenticated encryption apparatus 10 includes an input unit 100, a nonce generation unit 101, a Tweak encryption unit 102 (i.e., Tweakable encryption unit), a checksum generation unit 103, a header hash unit 104, a nonce encryption unit 105, an addition unit 106, a shortening unit 107, and an output unit 108. The authenticated encryption apparatus 10 can be implemented, for example, by a computer. That is, the authenticated encryption apparatus 10 includes an arithmetic device such as a CPU (Central Processing Unit) and a storage device such as a memory or a disc. The authenticated encryption apparatus 10 implements the above-described components by, for example, having the arithmetic device execute a program(s) stored in the storage device.

The input unit 100 has a function as input means. The nonce generation unit 101 has a function as nonce generation means. The Tweak encryption unit 102 has a function as Tweak encryption means (plaintext encryption means or ciphertext generation means). The checksum generation unit 103 has a function as checksum generation means. The header hash unit 104 has a function as header hash means (hash means). The nonce encryption unit 105 has a function as nonce encryption means. The addition unit 106 has a function as addition means. The shortening unit 107 has a function of shortening means (authentication tag generation means). The output unit 108 has a function as output means.

The input unit 100 receives an input of a plaintext M to be encrypted, and a header A. The input unit 100 may be implemented by, for example, an input device such as a keyboard. The input unit 100 may receive the input of the plaintext M and the header A from, for example, an external apparatus connected to thereto through a network. Note that there are cases where there is no header, and in such cases, the header A is not input to the input unit 100. The input unit 100 outputs the plaintext M to the Tweak encryption unit 102 and the checksum generation unit 103. Further, the input unit 100 outputs the header A to the header hash unit 104.

The nonce generation unit 101 generates a nonce N in such a manner that it does not to coincide with any of the past values. That is, the nonce generation unit 101 generates a nonce N that is different from any of the values generated in the past. Specifically, for example, the nonce generation unit 101 first outputs an arbitrary fixed value. Further, the nonce generation unit 101 retains a nonce value generated the last time. Then, the nonce generation unit 101 outputs a value that is obtained by adding 1 to the retained last value when it generates a nonce N at the second time or subsequent thereto. As described above, the nonce generation unit 101 generates a nonce N different from any of the values generated in the past by outputting a value obtained by adding 1 to the value that was output the last time. Note that the nonce generation unit 101 may generate a nonce by a method different from the above-described example method as long as it can generate a value different from any of the values generated in the past. The nonce generation unit 101 outputs the generated nonce N to the Tweak encryption unit 102 and the nonce encryption unit 105. Further, the nonce generation unit 101 may output the generated nonce N to the output unit 108.

The Tweak encryption unit 102 generate a ciphertext C by dividing the plaintext M into n-bit blocks, in which n is a predetermined number, and encrypting these blocks of the plaintext M in parallel with each other by using the nonce N as an auxiliary variable (i.e., as a Tweak). Specifically, the Tweak encryption unit 102 obtains a series of m blocks M[1], M[2], . . . , and M[m] by dividing the plaintext M into n-bit blocks (i.e., into blocks each having a predetermined length). Then, the Tweak encryption unit 102 includes (i.e., incorporates), for each of i-th M[i] (i=1, 2, . . . , m), the nonce N and the index i of the block into an auxiliary variable called a Tweak, and encrypts these blocks in parallel with each other by Tweakable block cipher. As a result, the Tweak encryption unit 102 obtains a ciphertext C=(C[1], C[2], . . . , C[m]) having the same length as that of the m blocks, which have been obtained by dividing the plaintext M. Note that the plaintext M does not necessarily have to be divided by the Tweak encryption unit 102. The plaintext M may have already been divided into m blocks, i.e., a series of blocks M[1], M[2], . . . , and M[m], when the plaintext M is input to the input unit 100. Alternatively, the input unit 100 may divide the plaintext M.

Note that the Tweak may include an index j indicating a type of process (e.g., indicating whether the target of the encryption is a plaintext or a nonce). Note that when the index j is 1 and the encryption function of the Tweakable block cipher is represented by TE (Tweak, message block), C[i] and C[m] can be expressed as follows.

C[i]=TE((N, i, j), M[i]) for i=1, . . . , m−1

C[m]=TE((N, m, j+1), M[m]) (Expression 1)

The Tweak encryption unit 102 obtains a ciphertext C by connecting the obtained blocks C[1], . . . , and C[m]. Then, the Tweak encryption unit 102 outputs the obtained ciphertext C to the output unit 108.

Note that, as shown in the Expression 1, for the safety, it is necessary to change, only in the last block (the block C[m]), the index j indicating the type of the process from the index j in the other blocks. Therefore, in the block C[m], this index is changed to j+1. Further, when the length of the plaintext M is not equal to a multiple of n, the Tweak encryption unit 102 applies appropriate unique padding that can be decrypted, and then obtains blocks M[1], M[2], . . . , M[m].

The Tweak encryption unit 102 may use, for example, a known algorithm such as SKINNY disclosed in Non-patent Literature 5 as the Tweakable block cipher (TBC). Alternatively, the Tweak encryption unit 102 may implement the Tweakable block cipher (TBC) in a block cipher use mode (hereinafter also referred to simply as a mode) using block cipher such as an AES (Advanced Encryption Standard). In this case, the Tweak encryption unit 102 can use an XEX* mode disclosed in Non-patent Literature 2 or a mode disclosed in Non-patent Literature 4, which is a variant of the XEX* mode, as the mode of the Tweakable block cipher. That is, in this example embodiment, the Tweakable block cipher may be the XEX* mode using block cipher.

Note that the encryption function of block cipher is represented by E. Further, the Tweak is represented by (N, i, j); the plaintext is represented by M; and the ciphertext is represented by C. In this case, the encryption in the XEX* mode is expressed by the below-shown Expression 2. This expression is expressed by the upper part of FIG. 10.

C=g(N, i, j)+E(M+g(N, i, j)),

g(N, i, j)=E(N)·2\hat{ }2·3\hat{ }j (Expression 2)

Note that “·2” means a multiplication with a generator (x in the polynomial expression) on a finite field GF(2\hat{ }n), and “·3” means a multiplication with the sum of the generator and the unit element (x+1 in the polynomial expression). Further, “E(N)·2i3\hat{ }j” means that E(N), which is regarded as the element of GF(2\hat{ }n), is multiplied by the generator i times, and is multiplied by the sum of the generator and the unit element j times. Note that these constant multiplications on GF (2\hat{ }n) are carried out through very simple processing. Further, in the above-described method, the safety is guaranteed when n is equal to 128. A method for implementing the encryption function of block cipher in the case where n is not equal to 128 is disclosed in, for example, Non-patent Literature 3.

Note that in the case where the process performed by using the Tweakable block cipher is not the above-described encryption process, and a message hash process or the like is instead performed, the function g(N, i, j) outside the encryption function E in the above-shown Expression 2 is omitted, so that it may be expressed as follows.

C=E(M+g(N, i, j)) (Expression 3)

For example, a process performed by the header hash unit 104 (which will be described later) corresponds to this expression.

The checksum generation unit 103 generates a checksum S by compressing the plaintext M through simple calculation. Specifically, the checksum generation unit 103 divides the plaintext M into a series of n bit blocks M[1], M[2], . . . , and M[m]. Then, the checksum generation unit 103 generates a checksum S by performing a simple compressing process on the series of divided n-bit blocks M[1], M[2], . . . , and M[m]. The checksum generation unit 103 outputs the generated checksum S to the addition unit 106.

When the checksum generation unit 103 uses, for example, exclusive OR +, it generates the checksum S by performing calculation according to the below-shown expression.

S=M[1]+M[2]+ . . . +M[m] (Expression 4)

Note that the calculation performed by the checksum generation unit 103 is not limited to the exclusive OR. For example, the checksum generation unit 103 may generate the checksum S by using any group or ring operation such as arithmetic addition.

The header hash unit 104 acquires a hash value H of the header A by using the header A and a universal hash function. Specifically, the header hash unit 104 converts the header A into a series of n-bit blocks A[1], A[2], . . . , and A[a]. Then, the header hash unit 104 acquires the hash value H of the header by applying the universal hash function to the series of n-bit blocks A[1], A[2], . . . , and A[a]. The header hash unit 104 outputs the acquired hash value H of the header to the addition unit 106.

Note that the header hash unit 104 may use, as the universal hash function, a polynomial hash function using multiplication such as one disclosed in Non-patent Literature 6. Alternatively, the header hash unit 104 may generate the hash value H of the header by a method using block cipher or Tweakable block cipher. The header hash unit 104 may acquire the hash value H according to the below-shown Expression 5 by using, for example, a method disclosed in Non-patent Literature 2 and using the TE function used in the Tweak encryption unit 102 as the universal hash function.

H=TE((const, I, j′), A[1])+TE((const, 2, j′), A[2])+ . . . +TE((const, a, j′), A[a]) (Expression 5)

In the expression const represents an arbitrary n-bit constant. Further, j′ is an arbitrary integer (e.g., j′−3) different from the index j used in the Tweak encryption unit 102. Further, as described above, the Tweakable block cipher may be the XEX* mode using block cipher.

Based on the above-shown Expression 5, the header hash unit 104 encrypts the blocks A in parallel with each other by the Tweakable block cipher by using, for the i-th header block A[i], a Tweak including the index i of the block of the header. Then, the header hash unit 104 acquires the hash value H of the header by adding all the encrypted blocks for i=1, . . . , a.

Note that, in the case where the length of the header A is not equal to a multiple of n, the header hash unit 104 applies appropriate padding and then divides the header A into blocks A[1], A[2], . . . , and A[a]. Note that in the case where there is no header, the header hash unit 104 may use an arbitrary constant (e.g., all zeros; a constant in which all the bit values are zero) as the hash value H.

The nonce encryption unit 105 encrypts the nonce N and thereby acquires an encrypted nonce V having the same length as that of the checksum. Specifically, the nonce encryption unit 105 generates the encrypted nonce V by encrypting an arbitrary n-bit constant by using the nonce N as an auxiliary variable (i.e., as a Tweak). That is, the nonce encryption unit 105 generates, by using a Tweak including the nonce N, the encrypted nonce V by performing encryption by Tweakable block cipher in which an arbitrary constant is used as a one-block plaintext. The nonce encryption unit 105 outputs the generated encrypted nonce V to the addition unit 106. Further, as described above, the Tweakable block cipher may be the XEX* mode using block cipher.

For example, the nonce encryption unit 105 can generate the encrypted nonce V by using the TE function used in the process performed by the Tweak encryption unit 102 as follows. That is, the nonce encryption unit 105 can generate the encrypted nonce V by using the below-shown Expression 6 by using a value j″ (e.g., j″=4) that has not been used as the index indicating the type of the process in the past.

V=TE((N, 0, j40 ″), 00 . . . 0) (Expression 6)

In the expression, “00 . . . 0” indicates n bits composed of all zeros.

The addition unit 106 generates a non-shortened authentication tag U by calculating the sum of the checksum S, the encrypted nonce V, and the hash value H of the header. Specifically, the addition unit 106 adds the hash value H of the header, the checksum S, and the encrypted nonce V. The addition unit 106 acquires this sum as the n-bit non-shortened authentication tag U. Note that the addition method may be exclusive OR or an arbitrary group addition operation. The addition unit 106 outputs the obtained non-shortened authentication tag U to the shortening unit 107.

The shortening unit 107 generate an authentication tag T by shortening the non-shortened authentication tag U generated by the addition unit 106 to t bits (t is a predetermined integer no smaller than 1 and no larger than n) by an arbitrary method. Specifically, the shortening unit 107 generates the authentication tag T by shortening the non-shortened authentication tag U to t-bit (t is a predetermined number) by an arbitrary method. For example, the shortening unit 107 may use the highest t bits of the non-shortened authentication tag U as the authentication tag T.

The output unit 108 performs control for outputting the ciphertext C and the authentication tag T. Note that the output unit 108 may connect the ciphertext C and the authentication tag T and output them in the connected state. The output unit 108 may, for example, perform control for displaying the ciphertext C and the authentication tag T on an output device such as a display. Further, the output unit 108 may, for example, perform control for outputting the ciphertext C and the authentication tag T to an external apparatus connected thereto through a network. Further, the output unit 108 may perform control so as to output the nonce N and the header A.

Next, the authenticated decryption apparatus 20 shown in FIG. 3 will be described. The authenticated decryption apparatus 20 includes an input unit 200, a Tweak decryption unit 201 (i.e., Tweakable decryption unit), a checksum generation unit 202, a nonce encryption unit 203, a header hash unit 204, an addition unit 205, a shortening unit 206, and a tag verification unit 207. The authenticated decryption apparatus 20 can be implemented, for example, by a computer. That is, the authenticated decryption apparatus 20 includes an arithmetic device such as a CPU and a storage unit such as a memory or a disc. The authenticated decryption apparatus 20 implements the above-described components by, for example, having the arithmetic device execute a program(s) stored in the storage device.

The input unit 200 has a function as input means. The Tweak decryption unit 201 has a function as tweak decryption means (plaintext decryption means or plaintext generation means). The checksum generation unit 202 has a function as checksum generation means. The nonce encryption unit 203 has a function as nonce encryption means. The header hash unit 204 has a function as header hash means (hash means). The addition unit 205 has a function as addition means. The shortening unit 206 has a function as shortening means (verification tag generation means). The tag verification unit 207 functions as tag verification means (verification means and output means).

The input unit 200 receives an input of a ciphertext C to be decrypted, a nonce N, a header A, and an authentication tag T. The input unit 200 may be implemented, for example, by a text input device such as a keyboard. The input unit 200 is implemented, for example, by an input device such as a keyboard. The input unit 200 may receive the ciphertext C, the nonce N, the header A, and the authentication tag T from, for example, an external apparatus connected thereto through a network. Note that there are cases where there is no header, and in such cases, the header A is not input to the input unit 200. The input unit 200 outputs the ciphertext C to the Tweak decryption unit 201. Further, the input unit 200 outputs the header A to the header hash unit 204. Further, the input unit 200 outputs the nonce N to the Tweak decryption unit 201 and the nonce encryption unit 203. Further, the input unit 200 outputs the authentication tag T to the tag verification unit 207.

The Tweak decryption unit 201 performs a decryption process corresponding to the above-described process performed by the Tweak encryption unit 102. The Tweak decryption unit 201 generates a plaintext M by dividing the ciphertext C into n-bit blocks, in which n is a predetermined number, decrypting these blocks of the ciphertext C in parallel with each other by using the nonce N as an auxiliary variable (i.e., as a Tweak). Specifically, the Tweak decryption unit 201 obtains a series of m blocks C[1], C[2], . . . , and C[m] by dividing the ciphertext C into n-bit blocks. Then, the Tweak decryption unit 201 includes (i.e., incorporates), for each of i-th C[i] (i=1, 2, . . . , m), the nonce N and the index i of the block into an auxiliary variable called a Tweak, and decrypts these blocks in parallel with each other by Tweakable block cipher. As a result, the Tweak decryption unit 201 obtains a plaintext M=(M[1], M[2], . . . , M[m]) having the same length as that of the m blocks, which have been obtained by dividing the ciphertext C. Note that the ciphertext C does not necessarily have to be divided by the Tweak decryption unit 201. The ciphertext C may have already been divided into m blocks, i.e., a series of blocks C[1], C[2], . . . , and C[m] when the ciphertext C is input to the input unit 200. Alternatively, the input unit 200 may divide the ciphertext C.

Note that, as described above, the Tweak may include an index j indicating a type of a process (e.g., indicating whether the target of the encryption is a plaintext or a nonce). When the above-described index j is 1 and the decryption function of the Tweakable block cipher is represented by TD (Tweak, message block), M[i] and M[m] can be expressed as follows.

M[i]=TD((N, i, j), C[i]) for i=1, . . . , m−1

M[m]=((N, m, j+1), C[m]) (Expression 7)

The Tweak decryption unit 201 connects the obtained blocks M[1], . . . , and M[m] to one another, and outputs the connected blocks as the plaintext M. Then, the Tweak decryption unit 201 outputs the obtained plaintext M to the tag verification unit 207 and the checksum generation unit 202. Note that, as shown in the Expression 7, for the safety, it is necessary to change, only in the last block (the block C[m]), the index j indicating the type of the process from the index j in the other blocks. Therefore, in the block M[m], this index is changed to j+1.

Note that, similarly to the Tweak encryption unit 102, the Tweak decryption unit 201 may use, as the Tweakable block cipher (TBC), a known algorithm for the Tweakable block cipher such as SKINNY disclosed in Non-patent Literature 5. Alternatively, the Tweak decryption unit 201 may implement the Tweakable block cipher (TBC) in a mode using block cipher such as the AES. In this case, the Tweak decryption unit 201 can use an XEX* mode disclosed in Non-patent Literature 2 or a mode disclosed in Non-patent Literature 4, which is a variant of the XEX* mode, as the mode of the Tweakable block cipher. That is, in this example embodiment, the Tweakable block cipher may be the XEX* mode using block cipher.

Assume a case where the XEX* mode disclosed in Non-patent Literature 2 is used as the mode of the Tweakable block cipher. The encryption function of the block cipher is represented by E and the decryption function thereof is represented by D. Further, the Tweak is represented by (N, i, j); the plaintext is represented by M; and the ciphertext is represented by C. In this case, the decryption in the XEX* mode is expressed by the below-shown Expression 8. This expression is expressed by the lower part of FIG. 10.

M=g(N, i, j)+D(C+g(N, i, j)),

g(N, i, j)=E(N)·2\hat{ }i·3\hat{ }3j (Expression 8)

Note that the definition and the like of the function g are substantially the same as those of the above-shown Expression 2 (the Tweak encryption unit 102). Further, in the above-described method, the safety is guaranteed when n is equal to 128.

The checksum generation unit 202 performs substantially the same process as that performed by the above-described checksum generation unit 103. That is, the checksum generation unit 202 generates a checksum S by compressing the plaintext M through simple calculation. The checksum generation unit 202 outputs the generated checksum S to the addition unit 205.

The nonce encryption unit 203 performs substantially the same process as that performed by the above-described nonce encryption unit 105. That is, the nonce encryption unit 203 encrypts the nonce N and thereby acquires the encrypted nonce V having the same length as that of the checksum. Specifically, the nonce encryption unit 203 generates the encrypted nonce V by encrypting an arbitrary n-bit constant by using the nonce N as an auxiliary variable (i.e., as a Tweak). That is, the nonce encryption unit 203 generates, by using a Tweak including the nonce N, the encrypted nonce V by performing encryption by Tweakable block cipher in which an arbitrary constant is used as a one-block plaintext. The nonce encryption unit 203 outputs the acquired encrypted nonce V to the addition unit 205. Further, as described above, the Tweakable block cipher may be the XEX* mode using block cipher.

The header hash unit 204 performs substantially the same process as that performed by the above-described header hash unit 104. That is, the header hash unit 204 acquires a hash value H of the header A by using the header A and a universal hash function. The header hash unit 204 outputs the acquired hash value H to the addition unit 205. Note that in the case where there is no header, the header hash unit 204 may use an arbitrary constant (e.g., all zeros; a constant in which all the bit values are zero) as the hash value H.

Specifically, the header hash unit 204 converts the header A into a series of n-bit blocks A[1], A[2], . . . , and A[a]. Then, the header hash unit 204 acquires the hash value H of the header by applying the universal hash function to the series of divided n-bit blocks A[1], A[2], . . . , and A[a]. Then, based on the above-shown Expression 5, the header hash unit 204 encrypts the blocks A in parallel with each other by the Tweakable block cipher by using, for the i-th header block A[i], a Tweak including the index i of the block of the header. Then, the header hash unit 204 acquires the hash value H of the header by adding all the encrypted blocks for i=1, . . . , a. Further, as described above, the Tweakable block cipher may be the XEX* mode using block cipher.

The addition unit 205 performs substantially the same process as that performed by the above-described addition unit 106. That is, the addition unit 205 generates a non-shortened authentication tag U by calculating the sum of the checksum S, the encrypted nonce V, and the hash value H of the header. The addition unit 205 outputs the generated non-shortened authentication tag U to the shortening unit 206.

The shortening unit 206 generate a verification tag T′, i.e., an inferred authentication tag T, by shortening the non-shortened authentication tag U generated by the addition unit 205 to t bits (t is a predetermined integer no smaller than 1 and no larger than n) by an arbitrary method. Note that the specific process performed by the shortening unit 206 is substantially the same as that performed by the shortening unit 107. The shortening unit 206 outputs the generated verification tag T′ to the tag verification unit 207.

The tag verification unit 207 verifies whether or not there is tampering by comparing the authentication tag T output from the input unit 200 with the verification tag T′ output from the shortening unit 206. Then, the tag verification unit 207 performs control for outputting information based on the result of the verification. Note that the tag verification unit 207 may perform control, for example, for displaying information on an output device such as a display. Further, the tag verification unit 207 may perform control so as to, for example, output information to an external apparatus connected thereto through a network.

Specifically, when the authentication tag T matches the verification tag T′, the tag verification unit 207 performs control for outputting the plaintext M generated by the Tweak decryption unit 201. Note that, in the case where the length of the plaintext is not equal to a multiple of the number n, the tag verification unit 207 may perform control so as to remove the predetermined padding and then output the plaintext M. On the other hand, when the authentication tag T does not match the verification tag T′, the tag verification unit 207 performs control so as to output an error symbol indicating that the authentication tag T does not match the verification tag T′.

Next, operations performed by the authenticated encryption system 1 according to the first example embodiment will be described with reference to FIGS. 4 and 5. FIG. 4 is a flowchart showing an authenticated encryption method performed by the authenticated encryption apparatus 10 according to the first example embodiment.

The input unit 100 inputs a plaintext M and a header A (Step S100). Specifically, as described above, the input unit 100 inputs a plaintext M=(M[1], M[2], . . . , M[m]) to be encrypted, and a header A. The nonce generation unit 101 generates a nonce N as described above (Step S102).

Next, the Tweak encryption unit 102 acquires a ciphertext C by encrypting each of the blocks of the plaintext M by using the nonce N as an auxiliary variable Tweak as described above (Step S104). Next, the checksum generation unit 103 generates a checksum S of the plaintext M as described above (Step S106). Next, the header hash unit 104 acquires a hash value H of the header A as described above (Step S108). Next, the nonce encryption unit 105 acquires an encrypted nonce V by encrypting the nonce N as described above (Step S110).

Next, the authenticated encryption apparatus 10 acquires an authentication tag T (Step S112). Specifically, the addition unit 106 calculates the sum of the checksum S, the encrypted nonce V, and the hash value H of the header as described above. The shortening unit 107 acquires the authentication tag T by shortening the sum (i.e., the non-shortened authentication tag U) to predetermined t bits (i.e., to t bits where t is a predetermined number). Then, the output unit 108 performs control for outputting the ciphertext C and the authentication tag T as described above (Step S114).

FIG. 5 is a flowchart showing an authenticated decryption method performed by the authenticated decryption apparatus 20 according to the first example embodiment. As described above, the input unit 200 inputs the ciphertext C to be decrypted, the nonce N, the header A, and the authentication tag T (Step S202). Next, the nonce encryption unit 203 acquires an encrypted nonce V by encrypting the nonce N as described above (Step S204). Next, the Tweak decryption unit 201 acquires a plaintext M by decrypting each of the blocks of the ciphertext C by using the nonce N as an auxiliary variable Tweak as described above (Step S206). Next, the header hash unit 204 acquires a hash value H of the header A as described above (Step S208). Next, the checksum generation unit 202 generates a checksum S of the plaintext M as described above (Step S210).

Next, the authenticated decryption apparatus 20 acquires an inferred authentication tag T′ (i.e., a verification tag) (Step S212). Specifically, the addition unit 205 calculates the sum of the encrypted nonce V, the hash value H of the header, and the checksum S as described above. The shortening unit 206 acquires an inferred authentication tag T′ (a verification tag T′) by shortening the sum (i.e., the non-shortened authentication tag U) to the predetermined t bits.

The tag verification unit 207 determines whether or not the authentication tag T matches the verification tag T′ (Step S214). In this way, it is verified whether or not there is tampering. When the authentication tag T matches the verification tag T′ (Yes in Step S214), the tag verification unit 207 performs control for outputting the plaintext M as a result of the verification indicating that the authentication has succeeded (Step S216). On the other hand, when the authentication tag T does not match the verification tag T′ (No in Step S214), the tag verification unit 207 performs control for outputting an error symbol as a result of the verification indicating that the authentication has failed (Step S218).

Next, advantageous effects of the authenticated encryption system 1 according to the first example embodiment will be described.

As described above, in the OCB and ThetaCB3, although the delay in encryption is small, the delay in decryption is larger than the delay in encryption. Specifically, the decryption delay is 3 in the OCB, and the decryption delay is 2 in the ThetaCB3. As described above, the reason why the decryption delay becomes larger than the encryption delay lies in the method for calculating the authentication tag which is used to detect tampering. The ThetaCB3 will be described hereinafter.

FIG. 6 is a simplified diagram of an encryption routine using an authenticated encryption method disclosed in Non-patent Literature 4, i.e., a ThetaCB3 method. In FIG. 6, “TE (N, i, j)” represents a function TE ((N, i, j), *) which is obtained by applying a Tweak (N, i, j) to the first argument of the encryption function of the Tweakable block cipher. Further, “trunc” represents a function for shortening an input.

Further, FIG. 7 is a simplified diagram of a decryption routine using the authenticated encryption method disclosed in Non-patent Literature 4, i.e., the ThetaCB3 method. In FIG. 7, “TD (N, i, j)” represents a function TD ((N, i, j), *) obtained by applying a Tweak (N, i, j) to the first argument of the decryption function of the Tweakable block cipher.

As shown in FIG. 6, the authentication tag T is obtained by encrypting the sum (exclusive OR) of plaintext blocks called the checksum S by using the TE function (TE(N·m·2)) of the Tweakable block cipher. Further, the encryption of blocks can be performed in parallel for all the TE functions at the point when the inputs of values required for the encryption (i.e., the nonce N, the header A, and the plaintext M) are determined. Therefore, the delay in encryption is 1.

Meanwhile, in the decryption process shown in FIG. 7, the corresponding ciphertext blocks are decrypted by the decryption function TD of the Tweakable block cipher in order to obtain plaintext blocks. Further, after the plaintext blocks are obtained by the decryption, a checksum S is generated. Then, it is verified whether or not there is tampering by checking the match between the value of the authentication tag T′ obtained by encrypting the checksum S by using the TE function (TE(N·M.·2)) with the value of the transmitted authentication tag T. Therefore, since the decryption function TD and the encryption function TE (surrounded by dashed lines) of the Tweakable block cipher are called in series (i.e., one after another), the delay in decryption is 2. That is, in FIG. 7, the TE function surrounded by the dashed lines cannot be performed unless the plaintext blocks M[1], . . . , and M[m] are determined. Therefore, the delay is increased by 1 due to this TE function surrounded by the dashed lines.

Further, in the case of the OCB, in addition to the above-described process, it is necessary to encrypt a nonce (a public value used in the encryption, implemented by a counter or the like) by block cipher in order to implement the

TE function and the TD function by block cipher. Specifically, in the case of the OCB 2 or OCB 2f disclosed in Non-patent Literature 2 and Non-patent Literature 3, the delay is increased by 1 in the encryption and in the decryption. Therefore, in the case of the OCB, the encryption delay is 2 and the decryption delay is 3. That is, in both the OCB and ThetaCB3, the decryption delay is increased by 1 as compared to the encryption delay.

Further, in order to prevent or reduce the increase of the communication bandwidth due to the authentication tag, the length of the authentication tag is often shorter than one block. Further, as will be described later, the method according to the first example embodiment has an effect of reducing the decryption delay irrespective of the length of the authentication tag as compared to the above-described technology. That is, the method according to the first example embodiment has an effect that each of the encryption delay and the decryption delay corresponds to one execution of the Tweakable block cipher irrespective of the length of the tag.

FIG. 8 shows an example of an encryption process in the case where the authenticated encryption method according to the first example embodiment is performed by using Tweakable block cipher. Further, FIG. 9 shows an example of a decryption process in the case where the authenticated encryption method according to the first example embodiment is performed by using Tweakable block cipher. As shown in FIGS. 8 and 9, there is no dependence between both the TE functions and the TD functions both in the encryption (FIG. 8) and in the decryption (FIG. 9). That is, both the TE functions and the TD functions are completely parallel to each other (i.e., independent of each other). That is, in the encryption, all the TE functions shown in FIG. 8 can be performed in parallel with each other. Further, in the decryption, all the TE functions and TD functions shown in FIG. 9 can be performed in parallel with each other.

Therefore, the encryption delay and the decryption delay are both 1.

As described above, in the ThetaCB3 (FIGS. 6 and 7), which is a particularly efficient Tweakable block cipher-based authenticated encryption, while the encryption delay is 1, the decryption delay is 2. Note that, in the ThetaCB3, if the length t of the tag is n bits (i.e., if no shortening is performed), the decryption delay can be reduced to 1 by changing the decryption procedure. However, it is common to shorten the tag in order to prevent or reduce the increase of the communication bandwidth due to the authentication tag. Therefore, it is desirable if the delay can be reduced irrespective of the length of the tag.

Further, in the case where the length t of the tag is shorter than n bits, it is conceivable to shorten the outputs of the TE function and the TD function related to the generation of the checksum and the generation of the hash value of the header to t bits in advance. In this way, it is possible to reduce the amount of the memory required for the encryption or the decryption without changing the overall algorithm. However, in the ThetaCB3, the checksum cannot be shortened before being input into the Tweakable block cipher, so that the above-described reduction of the amount of the memory is impossible.

Further, when the Tweakable block cipher is implemented in some block cipher use mode (e.g., the XEX* mode used in the OCB disclosed in Non-patent Literature 2), overhead occurs in the calculation in the block cipher use mode. As a result, the delay increases both in the encryption and in the decryption. Specifically, when the XEX* mode is used, one execution of the encryption of the nonce always occurs as overhead. However, this fact also applies to the existing OCB. That is, when the method for implementing Tweakable block cipher is the same, the overhead is the same. As a result, the advantage of this example embodiment over the technologies disclosed in non-patent literatures, i.e., the advantage that the decryption delay is small is also obtained.

Specifically, in the OCB 2 or OCB 2f disclosed in Non-patent Literature 2 and Non-patent Literature 3, the XEX* mode is used, and the encryption delay is 2 and the decryption delay is 3. In contrast to this, in this example embodiment, when the same XEX* mode is used, the encryption delay and the decryption delay are both 2. Further, in the OCB 3 disclosed in Non-patent Literature 4, although it is limited to the cases where a variant of the XEX* mode is used and a counter is used for the nonce, it is possible to substantially eliminate the above-described calculation overhead. When this variant is used, both the encryption delay and the decryption delay are reduced by about 1 both in the OCB 3 and in this example embodiment as compared to the case where the XEX* mode is used. Therefore, in the OCB 3, the encryption delay is about 1 and the decryption delay is about 2. In contrast to this, in this example embodiment, both the encryption delay and the decryption delay are roughly equal to 1.

Further, in this example embodiment, even when a method corresponding to the ThetaCB3 is adopted, the advantages of the ThetaCB3, such as the rate of encryption and decryption being 1, parallel processing being possible, and provable security being obtained, are ensured. Therefore, in this example embodiment, it is possible to provide high-speed and low-delay authenticated encryption.

### Second Example Embodiment

Next, a second example embodiment will be described. As the second example embodiment, an outline of the configuration according to the first example embodiment is shown.

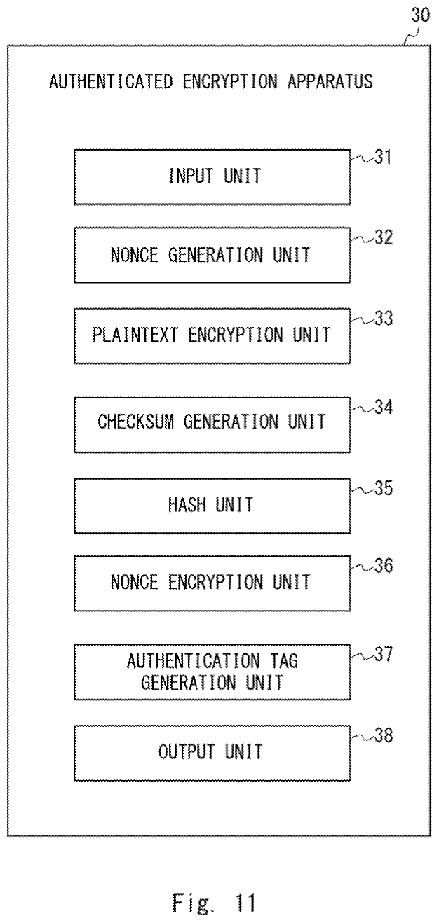

FIG. 11 shows an authenticated encryption apparatus 30 according to the second example embodiment. The authenticated encryption apparatus 30 according to the second example embodiment corresponds to the authenticated encryption apparatus 10 according to the first example embodiment. The authenticated encryption apparatus 30 according to the second example embodiment includes an input unit 31, a nonce generation unit 32, a plaintext encryption unit 33, a checksum generation unit 34, a hash unit 35, a nonce encryption unit 36, an authentication tag generation unit 37, and an output unit 38.

The input unit 31 has a function as input means (first input means). The nonce generation unit 32 has a function as nonce generation means. The plaintext encryption unit 33 has a function as plaintext encryption means (Tweak encryption means or ciphertext generation means). The checksum generation unit 34 has a function as checksum generation means (first checksum generation means). The hash unit 35 has a function as hash means (first hash means). The nonce encryption unit 36 has a function as nonce encryption means (first nonce encryption means). The authentication tag generation unit 37 has a function as authentication tag generation means (addition means and shortening means). The output unit 38 has a function as output means.

The input unit 31 can be implemented by substantially the same function as that of the input unit 100 shown in FIG. 2. The input unit 31 receives an input of a plaintext. Further, the input unit 31 may receive an input of a header. The nonce generation unit 32 can be implemented by substantially the same function as that of the nonce generation unit 101 shown in FIG. 2. The nonce generation unit 32 generates a nonce different from any of values generated in the past. The plaintext encryption unit 33 can be implemented by substantially the same function as that of the Tweak encryption unit 102 shown in FIG. 2. The plaintext encryption unit 33 generates a ciphertext corresponding to the plaintext by encrypting each of blocks obtained by dividing the plaintext by using the nonce as an auxiliary variable.

The checksum generation unit 34 can be implemented by substantially the same function as that of the checksum generation unit 103 shown in FIG. 2. The checksum generation unit 34 generates a checksum by using the plaintext. The hash unit 35 can be implemented by substantially the same function as that of the header hash unit 104 shown in FIG. 2. The hash unit 35 acquires a hash value. Note that when a header is input, the hash unit 35 may acquire a hash value by using the header and a hash function (a universal hash function). The nonce encryption unit 36 can be implemented by substantially the same function as that of the nonce encryption unit 105 shown in FIG. 2. The nonce encryption unit 36 acquires an encrypted nonce by encrypting the nonce.

The authentication tag generation unit 37 can be implemented by substantially the same functions as those of the addition unit 106 and the shortening unit 107 shown in FIG. 2. The authentication tag generation unit 37 generates an authentication tag by using the checksum, the hash value, and the encrypted nonce. Note that the authentication tag generation unit 37 may generate the authentication tag based on the sum of the checksum, the hash value, and the encrypted nonce. Further, the authentication tag generation unit 37 may generate the authentication tag by shortening the aforementioned sum. The output unit 38 can be implemented by substantially the same function as that of the output unit 108 shown in FIG. 2. The output unit 38 performs control for outputting the ciphertext and the authentication tag.

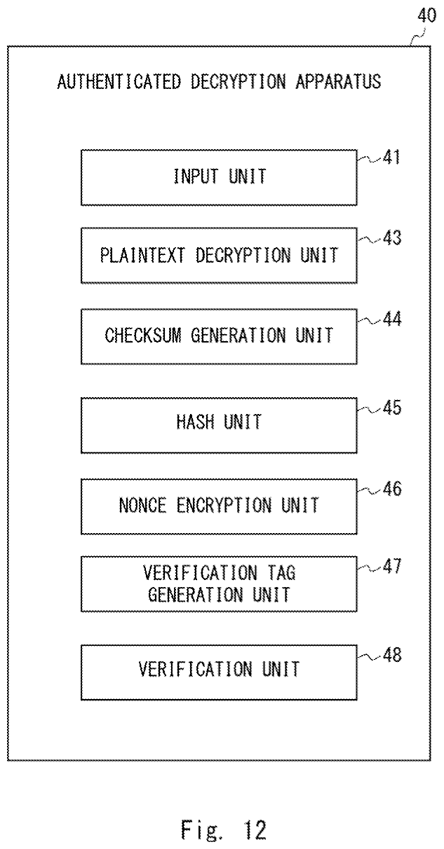

FIG. 12 shows an authenticated decryption apparatus 40 according to the second example embodiment. The authenticated decryption apparatus 40 according to the second example embodiment corresponds to the authenticated decryption apparatus 20 according to the first example embodiment. The authenticated decryption apparatus 40 according to the second example embodiment includes an input unit 41, a plaintext decryption unit 43, a checksum generation unit 44, a hash unit 45, a nonce encryption unit 46, a verification tag generation unit 47, and a verification unit 48.

The input unit 41 has a function as input means (second input means). The plaintext decryption unit 43 has a function as plaintext decryption means (Tweak decryption means or plaintext generation means). The checksum generation unit 44 has a function as checksum generation means (second checksum generation means). The hash unit 45 has a function as hash means (second hash means). The nonce encryption unit 46 has a function as nonce encryption means (second nonce encryption means). The verification tag generation unit 47 has a function as verification tag generation means (addition means and shortening means). The verification unit 48 functions as verification means (tag verification means and output means).

The input unit 41 can be implemented by substantially the same function as that of the input unit 200 shown in FIG. 3. The input unit 41 receives inputs of a ciphertext, an authentication tag, and a nonce. Note that the input unit 41 may receive an input of a header. The plaintext decryption unit 43 can be implemented by substantially the same function as that of the Tweak decryption unit 201 shown in FIG. 3. The plaintext decryption unit 43 generates a plaintext corresponding to the ciphertext by decrypting each of blocks obtained by dividing the ciphertext by using the nonce as an auxiliary variable.

The checksum generation unit 44 can be implemented by substantially the same function as that of the checksum generation unit 202 shown in FIG. 3. The checksum generation unit 44 generates a checksum by using the plaintext. The hash unit 45 can be implemented by substantially the same function as that of the header hash unit 204 shown in FIG. 3. The hash unit 45 acquires a hash value. Note that when a header is input, the hash unit 45 may acquire a hash value by using the header and a hash function (a universal hash function). The nonce encryption unit 46 can be implemented by substantially the same function as that of the nonce encryption unit 203 shown in FIG. 3. The nonce encryption unit 46 acquires an encrypted nonce by encrypting the nonce.

The verification tag generation unit 47 can be implemented by substantially the same functions as those of the addition unit 205 and the shortening unit 206 shown in FIG. 3. The verification tag generation unit 47 generates a verification tag, i.e., an inferred authentication tag, by using the checksum, the hash value, and the encrypted nonce. Note that the verification tag generation unit 47 may generate the verification tag based on the sum of the checksum, the hash value, and the encrypted nonce. Further, the verification tag generation unit 47 may generate the verification tag by shortening the aforementioned sum.

The verification unit 48 can be implemented by substantially the same function as that of the tag verification unit 207 shown in FIG. 3. The verification unit 48 verifies whether or not there is tampering by comparing the authentication tag with the verification tag, and performs control for outputting the result of the verification. Note that when the authentication tag matches the verification tag, the verification unit 48 may perform control for outputting the plaintext as the result of the verification. On the other hand, when the authentication tag does not match the verification tag, the verification unit 48 may perform control for outputting an error symbol as the result of the verification.

The authenticated encryption apparatus 30 and the authenticated decryption apparatus 40 according to the second example embodiment can reduce the delays in encryption and in decryption by the above-described configuration. Note that an authenticated encryption system including the authenticated encryption apparatus 30 and the authenticated decryption apparatus 40 can also reduce the delays in encryption and in decryption. Further, an authenticated encryption method performed by the authenticated encryption apparatus 30 and a program for performing the authenticated encryption method can also reduce the delays in encryption and in decryption. Further, an authenticated decryption method performed by the authenticated decryption apparatus 40 and a program for performing the authenticated decryption method can also reduce the delays in encryption and in decryption.

### Example of Hardware Configuration

An example of a configuration of hardware resources for implementing an apparatus and a system according to each of the above-described example embodiments by using one calculation processing apparatus (an information processing apparatus or a computer) will be described. However, the apparatus according to each example embodiment (the authenticated encryption apparatus and the authenticated decryption apparatus) may be implemented by using at least two physically or functionally separated calculation processing apparatuses. Further, the apparatus according to each example embodiment may be implemented as a dedicated apparatus or may be implemented by a general-purpose information processing apparatus.

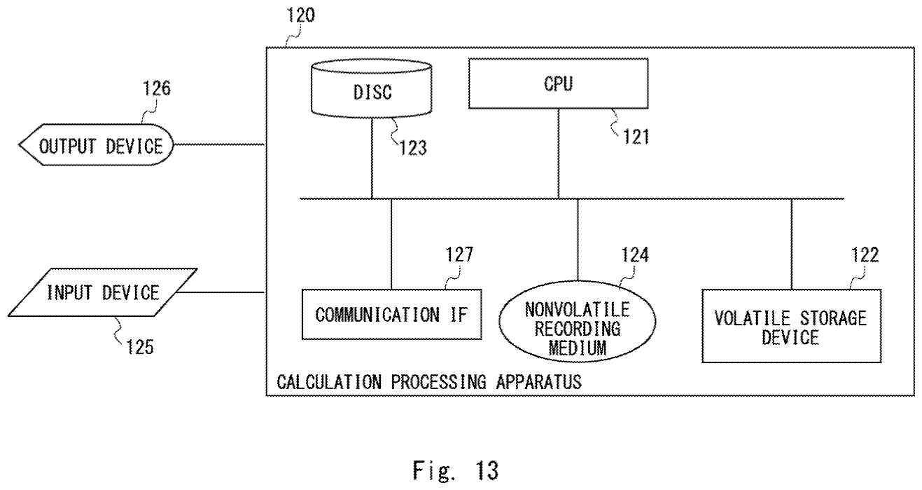

FIG. 13 is a block diagram schematically showing an example of a hardware configuration of a calculation processing apparatus capable of implementing an apparatus and a system according to each example embodiment. The calculation processing apparatus 120 includes a CPU 121, a volatile storage device 122, a disc 123, a nonvolatile recording medium 124, and a communication

IF (IF: Interface) 127. Therefore, the apparatus according to each example embodiment includes the CPU 121, the volatile storage device 122, the disc 123, the nonvolatile recording medium 124, and the communication IF 127. The calculation processing apparatus 120 may be configured so that an input device 125 and an output device 126 can be connected thereto. The calculation processing apparatus 120 may include the input device 125 and the output device 126. Further, the calculation processing apparatus 120 can transmit and receive information to and from other calculation processing apparatuses and communication apparatuses through the communication IF 127.

The nonvolatile recording medium 124 is, for example, a computer readable Compact Disc or a computer readable Digital Versatile Disc. Further, the nonvolatile recording medium 124 may be a USB (Universal Serial Bus) memory, a Solid State Drive, or the like. The nonvolatile recording medium 124 holds (i.e., retains) a relevant program(s) even when no electric power is supplied, thus enabling the program(s) to be carried and transported. Note that the nonvolatile recording medium 124 is not limited to the above-described media. Alternatively, instead of using the nonvolatile recording medium 124, the relevant program(s) may be supplied through the communication IF 127 and a communication network(s).

The volatile storage device 122 can be read by a computer, and can temporarily store data. The volatile storage device 122 is a memory or the like such as a DRAM (dynamic random access memory) or an SRAM (static random access memory).

That is, the CPU 121 copies (i.e., loads) a software program (a computer program: hereinafter also simply referred to as a “program”) stored in the disc 123 into the volatile storage device 122 when it executes the program, and thereby performs arithmetic processing. The CPU 121 reads data necessary for executing the program from the volatile storage device 122. When it is necessary to display an output result, the CPU 121 displays the output result on the output device 126. When a program is input from the outside, the CPU 121 acquires the program through the input device 125. The CPU 121 interprets and executes programs corresponding to the above-described functions (the processes) of the respective components shown in FIGS. 2, 3, 11 and 12. The CPU 121 performs the processes described in each of the above-described example embodiments. In other words, the above-described functions of the respective components shown in FIGS. 2, 3, 11 and 12 can be implemented by having the CPU 121 execute a program(s) stored in the disc 123 or the volatile storage device 122.

That is, it can be considered that each example embodiment can be accomplished by the above-described program. Further, it can be considered that each of the above-described example embodiments can also be accomplished by a nonvolatile recording medium which can be read by a computer and in which the above-described program is recorded.

### Modified Example

Note that the present invention is not limited to the above-described example embodiments, and they may be modified as appropriate without departing from the scope and spirit of the invention. For example, in the above-described flowcharts, the order of processes (steps) can be changed as appropriate. Further, at least one of a plurality of processes (steps) may be omitted (or skipped).

For example, in the flowchart shown in FIG. 4, the order of the processes in the steps S104 to S110 is not limited to the order shown in FIG. 4. Further, the processes in the steps S104 to S110 can be performed in parallel with each other. Similarly, in the flowchart shown in FIG. 5, the order of the processes in the steps S204, S206 and S208 is not limited to the order shown in FIG. 5. Further, the processes in the steps S204, S206 and S208 can be performed in parallel with each other.

In the above-described examples, the program can be stored and provided to a computer using any type of non-transitory computer readable media. Non-transitory computer readable media include any type of tangible storage media. Examples of non-transitory computer readable media include magnetic storage media (floppy disks, magnetic tapes, hard disk drives), optical magnetic storage media (e.g., magneto-optical disks), CD-ROM, CD-R, CD-R/W, and semiconductor memories (e.g., mask ROM, PROM (Programmable ROM), EPROM (Erasable PROM), flash ROM, and RAM). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present invention is explained above with reference to example embodiments, the present invention is not limited to the above-described example embodiments. Various modifications that can be understood by those skilled in the art can be made to the configuration and details of the present invention within the scope of the invention.

The whole or part of the example embodiments disclosed above can be described as, but not limited to, the following supplementary notes.

### Supplementary Note 1

An authenticated encryption apparatus comprising:

input means for receiving an input of a plaintext;

nonce generation means for generating a nonce different from a value generated in the past;

plaintext encryption means for generating a ciphertext corresponding to the plaintext by encrypting each of blocks obtained by dividing the plaintext by using the nonce as an auxiliary variable;

checksum generation means for generating a checksum by using the plaintext;

hash means for acquiring a hash value;

nonce encryption means for acquiring an encrypted nonce by encrypting the nonce;

authentication tag generation means for generating an authentication tag by using the checksum, the hash value, and the encrypted nonce; and

output means for performing control for outputting the ciphertext and the authentication tag.

### Supplementary Note 2

The authenticated encryption apparatus described in Supplementary note 1, wherein the authentication tag generation means generates the authentication tag based on a sum of the checksum, the hash value, and the encrypted nonce.

### Supplementary Note 3

The authenticated encryption apparatus described in Supplementary note 2, wherein the authentication tag generation means generates the authentication tag by shortening the sum.

### Supplementary Note 4

The authenticated encryption apparatus described in any one of Supplementary notes 1 to 3, wherein the nonce encryption means acquires the encrypted nonce having the same length as that of the checksum.

### Supplementary Note 5

The authenticated encryption apparatus described in any one of Supplementary notes 1 to 4, wherein

the input means receives a header, and

the hash means acquires the hash value by using the header and a hash function.

### Supplementary Note 6

The authenticated encryption apparatus described in any one of Supplementary notes 1 to 5, wherein the plaintext encryption means encrypts the blocks of the plaintext in parallel with each other by Tweakable block cipher by using a Tweak, the Tweak being the auxiliary variable which includes the nonce and an index i for an i-th block among the blocks of the plaintext, the blocks of the plaintext being obtained by dividing the plaintext into blocks each having a predetermined length.

### Supplementary Note 7

The authenticated encryption apparatus described in Supplementary note 6, wherein

the input means receives the header, and

the hash means acquires the hash value by encrypting the blocks of the header in parallel with each other by Tweakable block cipher by using a Tweak, the Tweak being the auxiliary variable which includes an index i for an i-th block among the blocks of the header, the blocks of the header being obtained by dividing the header into blocks each having a predetermined length.

### Supplementary Note 8

The authenticated encryption apparatus described in Supplementary note 7, wherein the hash means acquires the hash value by adding up the blocks obtained by encrypting the header.

### (Supplementary Note 9

The authenticated encryption apparatus described in any one of Supplementary notes 6 to 8, wherein the nonce encryption means acquires the encrypted nonce by encrypting the nonce by Tweakable block cipher by using a Tweak, the Tweak being the auxiliary variable including the nonce.

### Supplementary Note 10

The authenticated encryption apparatus described in any one of Supplementary notes 6 to 9, wherein the Tweakable block cipher is an XEX* mode using block cipher.

### Supplementary Note 11

An authenticated decryption apparatus comprising:

input means for receiving an input of a ciphertext, an authentication tag, and a nonce;

plaintext decryption means for generating a plaintext corresponding to the ciphertext by decrypting each of blocks obtained by dividing the ciphertext by using the nonce as an auxiliary variable;

checksum generation means for generating a checksum by using the plaintext;

hash means for acquiring a hash value;

nonce encryption means for acquiring an encrypted nonce by encrypting the nonce;

verification tag generation means for generating a verification tag by using the checksum, the hash value, and the encrypted nonce, the verification tag being an inferred authentication tag; and

verification means for verifying whether or not there is tampering by comparing the authentication tag with the verification tag, and performing control for outputting a result of the verification.

### Supplementary Note 12

The authenticated decryption apparatus described in Supplementary note 11, wherein the verification tag generation means generates the verification tag based on a sum of the checksum, the hash value, and the encrypted nonce.

### Supplementary Note 13

The authenticated decryption apparatus described in Supplementary note 12, wherein the verification tag generation means generates the verification tag by shortening the sum.

### Supplementary Note 14

The authenticated decryption apparatus described in any one of Supplementary notes 11 to 13, wherein the nonce encryption means acquires the encrypted nonce having the same length as that of the checksum.

### Supplementary Note 15

The authenticated decryption apparatus described in any one of Supplementary notes 11 to 14, wherein

the input means receives a header, and

the hash means acquires the hash value by using the header and a hash function.

### Supplementary Note 16

The authenticated decryption apparatus described in any one of Supplementary notes 11 to 15, wherein the plaintext decryption means decrypts the blocks of the ciphertext in parallel with each other by Tweakable block cipher by using a Tweak, the Tweak being the auxiliary variable which includes the nonce and an index i for an i-th block among the blocks of the ciphertext, the blocks of the ciphertext being obtained by dividing the ciphertext into blocks each having a predetermined length.

### Supplementary Note 17

The authenticated decryption apparatus described in Supplementary note 16, wherein

the input means receives the header, and

the hash means acquires the hash value by encrypting the blocks of the header in parallel with each other by Tweakable block cipher by using a Tweak, the Tweak being the auxiliary variable which includes an index i for an i-th block among the blocks of the header, the blocks of the header being obtained by dividing the header into blocks each having a predetermined length.

### Supplementary Note 18

The authenticated decryption apparatus described in Supplementary note 17, wherein the hash means acquires the hash value by adding up the blocks obtained by encrypting the header.

### Supplementary Note 19

The authenticated decryption apparatus described in any one of

Supplementary notes 16 to 18, wherein the nonce encryption means acquires the encrypted nonce by encrypting the nonce by Tweakable block cipher by using a Tweak, the Tweak being the auxiliary variable including the nonce.

### Supplementary Note 20

The authenticated decryption apparatus described in any one of Supplementary notes 16 to 19, wherein the Tweakable block cipher is an XEX* mode using block cipher.

### Supplementary Note 21

An authenticated encryption system comprising:

an authenticated encryption apparatus; and

an authenticated decryption apparatus configured to communicate with the authenticated encryption apparatus, wherein

the authenticated encryption apparatus comprises:

first input means for receiving an input of a plaintext;

nonce generation means for generating a nonce different from a value generated in the past;

plaintext encryption means for generating a ciphertext corresponding to the plaintext by encrypting each of blocks obtained by dividing the plaintext by using the nonce as an auxiliary variable;

first checksum generation means for generating a checksum by using the plaintext;

first hash means for acquiring a hash value;

first nonce encryption means for acquiring an encrypted nonce by encrypting the nonce;

authentication tag generation means for generating an authentication tag by using the checksum, the hash value, and the encrypted nonce; and

output means for performing control for outputting the ciphertext and the authentication tag, and

the authenticated decryption apparatus comprises:

second input means for receiving an input of a ciphertext, an authentication tag, and a nonce;

plaintext decryption means for generating a plaintext corresponding to the ciphertext by decrypting each of blocks obtained by dividing the ciphertext input through the second input means by using the nonce input through the second input means as an auxiliary variable;

second checksum generation means for generating a checksum by using the plaintext generated by the plaintext decryption means;

second hash means for acquiring a hash value;

second nonce encryption means for acquiring an encrypted nonce by encrypting the nonce input through the second input means;

verification tag generation means for generating a verification tag by using the checksum generated by the second checksum generation means, the hash value acquired by the second hash means, and the encrypted nonce acquired by the second nonce encryption means, the verification tag being an inferred authentication tag; and

verification means for verifying whether or not there is tampering by comparing the authentication tag generated by the authentication tag generation means with the verification tag, and performing control for outputting a result of the verification.

### Supplementary Note 22

An authenticated encryption method comprising:

receiving an input of a plaintext;

generating a nonce different from a value generated in the past;

generating a ciphertext corresponding to the plaintext by encrypting each of blocks obtained by dividing the plaintext by using the nonce as an auxiliary variable;

generating a checksum by using the plaintext;

acquiring a hash value;

acquiring an encrypted nonce by encrypting the nonce;

generating an authentication tag by using the checksum, the hash value, and the encrypted nonce; and

performing control for outputting the ciphertext and the authentication tag.

### Supplementary Note 23

An authenticated decryption method comprising:

receiving an input of a ciphertext, an authentication tag, and a nonce;

generating a plaintext corresponding to the ciphertext by decrypting each of blocks obtained by dividing the ciphertext by using the nonce as an auxiliary variable;

generating a checksum by using the plaintext;

acquiring a hash value;

acquiring an encrypted nonce by encrypting the nonce;

generating a verification tag by using the checksum, the hash value, and the encrypted nonce, the verification tag being an inferred authentication tag; and

verifying whether or not there is tampering by comparing the authentication tag with the verification tag, and performing control for outputting a result of the verification.

### Supplementary Note 24

A non-transitory computer readable medium storing a program for causing a computer to perform:

a step of receiving an input of a plaintext;

a step of generating a nonce different from a value generated in the past;

a step of generating a ciphertext corresponding to the plaintext by encrypting each of blocks obtained by dividing the plaintext by using the nonce as an auxiliary variable;

a step of generating a checksum by using the plaintext;

a step of acquiring a hash value;

a step of acquiring an encrypted nonce by encrypting the nonce;

a step of generating an authentication tag by using the checksum, the hash value, and the encrypted nonce; and

a step of performing control for outputting the ciphertext and the authentication tag.

### Supplementary Note 25

A non-transitory computer readable medium storing a program for causing a computer to perform:

a step of receiving an input of a ciphertext, an authentication tag, and a nonce;

a step of generating a plaintext corresponding to the ciphertext by

decrypting each of blocks obtained by dividing the ciphertext by using the nonce as an auxiliary variable;

a step of generating a checksum by using the plaintext;

a step of acquiring a hash value;

a step of acquiring an encrypted nonce by encrypting the nonce;

a step of generating a verification tag by using the checksum, the hash value, and the encrypted nonce, the verification tag being an inferred authentication tag; and

a step of verifying whether or not there is tampering by comparing the authentication tag with the verification tag, and performing control for outputting a result of the verification.

### REFERENCE SIGNS LIST

1 AUTHENTICATED ENCRYPTION SYSTEM
10 AUTHENTICATED ENCRYPTION APPARATUS
100 INPUT UNIT
101 NONCE GENERATION UNIT
102 TWEAK ENCRYPTION UNIT
103 CHECKSUM GENERATION UNIT
104 HEADER HASH UNIT
105 NONCE ENCRYPTION UNIT
106 ADDITION UNIT
107 SHORTENING UNIT
108 OUTPUT UNIT
20 AUTHENTICATED DECRYPTION APPARATUS
200 INPUT UNIT
201 TWEAK DECRYPTION UNIT
202 CHECKSUM GENERATION UNIT
203 NONCE ENCRYPTION UNIT
204 HEADER HASH UNIT
205 ADDITION UNIT
206 SHORTENING UNIT
207 TAG VERIFICATION UNIT
30 AUTHENTICATED ENCRYPTION APPARATUS
31 INPUT UNIT
32 NONCE GENERATION UNIT
33 PLAINTEXT ENCRYPTION UNIT
34 CHECKSUM GENERATION UNIT
35 HASH UNIT
36 NONCE ENCRYPTION UNIT
37 AUTHENTICATION TAG GENERATION UNIT
38 OUTPUT UNIT
40 AUTHENTICATED DECRYPTION APPARATUS
41 INPUT UNIT
43 PLAINTEXT DECRYPTION UNIT
44 CHECKSUM GENERATION UNIT
45 HASH UNIT
46 NONCE ENCRYPTION UNIT
47 VERIFICATION TAG GENERATION UNIT
48 VERIFICATION UNIT

What is claimed is:

1. An authenticated encryption apparatus comprising:
hardware, including a processor and memory;
input unit implemented at least by the hardware and configured to receive an input of a plaintext;
nonce generation unit implemented at least by the hardware and configured to generate a nonce different from a value generated in the past;
plaintext encryption unit implemented at least by the hardware and configured to generate a ciphertext corresponding to the plaintext by encrypting each of blocks obtained by dividing the plaintext by using the nonce as an auxiliary variable;
checksum generation unit implemented at least by the hardware and configured to generate a checksum by using the plaintext;
hash unit implemented at least by the hardware and configured to acquire a hash value;
nonce encryption unit implemented at least by the hardware and configured to acquire an encrypted nonce by encrypting the nonce;
authentication tag generation unit implemented at least by the hardware and configured to generate an authentication tag by using the checksum, the hash value, and the encrypted nonce; and
output unit implemented at least by the hardware and configured to perform control for outputting the ciphertext and the authentication tag.

2. The authenticated encryption apparatus according to claim 1, wherein the authentication tag generation unit generates the authentication tag based on a sum of the checksum, the hash value, and the encrypted nonce.

3. The authenticated encryption apparatus according to claim 2, wherein the authentication tag generation unit generates the authentication tag by shortening the sum.

4. The authenticated encryption apparatus according to claim 1, wherein the nonce encryption unit acquires the encrypted nonce having the same length as that of the checksum.

5. The authenticated encryption apparatus according to claim 1, wherein
the input unit receives a header, and
the hash unit acquires the hash value by using the header and a hash function.

6. The authenticated encryption apparatus according to claim 1, wherein the plaintext encryption unit encrypts the blocks of the plaintext in parallel with each other by Tweakable block cipher by using a Tweak, the Tweak being the auxiliary variable which includes the nonce and an index i for an i-th block among the blocks of the plaintext, the blocks of the plaintext being obtained by dividing the plaintext into blocks each having a predetermined length.

7. The authenticated encryption apparatus according to claim 6, wherein
the input unit receives the header, and
the hash unit acquires the hash value by encrypting the blocks of the header in parallel with each other by Tweakable block cipher by using a Tweak, the Tweak being the auxiliary variable which includes an index i for an i-th block among the blocks of the header, the blocks of the header being obtained by dividing the header into blocks each having a predetermined length.

8. The authenticated encryption apparatus according to claim 7, wherein the hash unit acquires the hash value by adding up the blocks obtained by encrypting the header.

9. The authenticated encryption apparatus according to claim 6, wherein the nonce encryption unit acquires the encrypted nonce by encrypting the nonce by Tweakable block cipher by using a Tweak, the Tweak being the auxiliary variable including the nonce.

10. The authenticated encryption apparatus according to claim 6, wherein the Tweakable block cipher is an XEX* mode using block cipher.

11. An authenticated decryption apparatus comprising:
hardware, including a processor and memory;
input unit implemented at least by the hardware and configured to receive an input of a ciphertext, an authentication tag, and a nonce;
plaintext decryption unit implemented at least by the hardware and configured to generate a plaintext corresponding to the ciphertext by decrypting each of blocks obtained by dividing the ciphertext by using the nonce as an auxiliary variable;
checksum generation unit implemented at least by the hardware and configured to generate a checksum by using the plaintext;
hash unit implemented at least by the hardware and configured to acquire a hash value;
nonce encryption unit implemented at least by the hardware and configured to acquire an encrypted nonce by encrypting the nonce;
verification tag generation unit implemented at least by the hardware and configured to generate a verification tag by using the checksum, the hash value, and the encrypted nonce, the verification tag being an inferred authentication tag; and
verification unit implemented at least by the hardware and configured to verify whether or not there is tampering by comparing the authentication tag with the verification tag, and perform control for outputting a result of the verification.

12. The authenticated decryption apparatus according to claim 11, wherein the verification tag generation unit generates the verification tag based on a sum of the checksum, the hash value, and the encrypted nonce.

13. The authenticated decryption apparatus according to claim 12, wherein the verification tag generation unit generates the verification tag by shortening the sum.

14. The authenticated decryption apparatus according to claim 11 wherein the nonce encryption unit acquires the encrypted nonce having the same length as that of the checksum.

15. The authenticated decryption apparatus according to claim 11, wherein
the input unit receives a header, and
the hash unit acquires the hash value by using the header and a hash function.

16. The authenticated decryption apparatus according to claim 11, wherein the plaintext decryption unit decrypts the blocks of the ciphertext in parallel with each other by Tweakable block cipher by using a Tweak, the Tweak being the auxiliary variable which includes the nonce and an index i for an i-th block among the blocks of the ciphertext, the blocks of the ciphertext being obtained by dividing the ciphertext into blocks each having a predetermined length.

17. The authenticated decryption apparatus according to claim 16, wherein
the input unit receives the header, and
the hash unit acquires the hash value by encrypting the blocks of the header in parallel with each other by Tweakable block cipher by using a Tweak, the Tweak being the auxiliary variable which includes an index i for an i-th block among the blocks of the header, the blocks of the header being obtained by dividing the header into blocks each having a predetermined length.

18. The authenticated decryption apparatus according to claim 17, wherein the hash unit acquires the hash value by adding up the blocks obtained by encrypting the header.

19. The authenticated decryption apparatus according to claim 16, wherein the nonce encryption unit acquires the encrypted nonce by encrypting the nonce by Tweakable block cipher by using a Tweak, the Tweak being the auxiliary variable including the nonce.

20. The authenticated decryption apparatus according to claim 16, wherein the Tweakable block cipher is an XEX* mode using block cipher.

21. (canceled)

22. An authenticated encryption method comprising:
receiving an input of a plaintext;
generating a nonce different from a value generated in the past;
generating a ciphertext corresponding to the plaintext by encrypting each of blocks obtained by dividing the plaintext by using the nonce as an auxiliary variable;
generating a checksum by using the plaintext;
acquiring a hash value;
acquiring an encrypted nonce by encrypting the nonce;
generating an authentication tag by using the checksum, the hash value, and the encrypted nonce; and
performing control for outputting the ciphertext and the authentication tag.

23. An authenticated decryption method comprising:
receiving an input of a ciphertext, an authentication tag, and a nonce;
generating a plaintext corresponding to the ciphertext by decrypting each of blocks obtained by dividing the ciphertext by using the nonce as an auxiliary variable;
generating a checksum by using the plaintext;
acquiring a hash value;
acquiring an encrypted nonce by encrypting the nonce;
generating a verification tag by using the checksum, the hash value, and the encrypted nonce, the verification tag being an inferred authentication tag; and
verifying whether or not there is tampering by comparing the authentication tag with the verification tag, and performing control for outputting a result of the verification.

24. A non-transitory computer readable medium storing a program for causing a computer to perform:
a step of receiving an input of a plaintext;
a step of generating a nonce different from a value generated in the past;
a step of generating a ciphertext corresponding to the plaintext by encrypting each of blocks obtained by dividing the plaintext by using the nonce as an auxiliary variable;
a step of generating a checksum by using the plaintext;
a step of acquiring a hash value;
a step of acquiring an encrypted nonce by encrypting the nonce;
a step of generating an authentication tag by using the checksum, the hash value, and the encrypted nonce; and
a step of performing control for outputting the ciphertext and the authentication tag.

25. (canceled)
